(19) United States
(12) Patent Application Publication
(10) Pub. No.: US 2012/0312142 A1
(43) Pub. Date: Dec. 13, 2012

(54) GUITAR WITH HANDLE FIXED WITH FAST-FIXING MEANS

(75) Inventor: Adalberto Serrangeli, Porto Recanati (MC) (IT)

(73) Assignee: EKO MUSIC GROUP S.P.A., Recanati (MC) (IT)

(21) Appl. No.: 13/578,496

(22) PCT Filed: Jan. 25, 2011
(86) PCT No.: PCT/EP11/50998

§ 371 Date: Aug. 10, 2012

(30) Foreign Application Priority Data
Feb. 2, 2010 (MC) MC2010A000019

(51) Int. Cl. G10D 1/08

(52) U.S. Cl. 84/267

(57) ABSTRACT

A guitar comprising a handle fixed to the body by a tightening pin and a cylindrical stem, perpendicularly fixed to the end section of the handle and provided, near the tip, with a diametral hole. The opposite openings of the hole are given elliptical flaring, with truncatedconical pro file, adapted to interact with the conical tip of the tightening pin. The pin is screwed into an element with longitudinal axis orthogonal to the axis of the cylindrical stem and recessed into the centre of the lateral wall of the body of the guitar, in an area under the attachment comer of the handle to the body.

The present patent application for invention relates to a guitar, the handle of which is fixed to the body with fixing means that allow for assembling and disassembling the handle rapidly and are associated with a fine adjustment screw of its inclination.

In order to better appreciate the advantages offered by the invention, it must be noted that the handle is generally glued to the guitar body, by joining the end of the handle and the relevant seat on the body.

Said coupling is normally of dovetail type. In some models of guitars the handle is fixed to the body by means of cylindrical wooden pegs that are forced inside corresponding holes obtained on a wooden reinforcement block, normally called “wedge”, contained inside the body in the handle fixing area.

For guitars with twelve strings, in which the handle is subject to a particularly heavy stress when all strings are stretched at the correct value, it is preferable to use more energetic and more reliable fixing systems, according to which a rectangular metal plate is applied centrally on the back side of the body near the edge.

The end section of the handle is inserted into a corresponding seat obtained on the edge of the body, where it is fixed by means of four self-tapping screws inserted through corresponding holes obtained at the four angles of the metal plate.

The stem of said screws is designed to be engaged deeply in the handle until the head of said screws is engaged against said metal reinforcement plate.

The purpose of the present invention is to devise a guitar that comprises new fixing means for rapid and precise fixing of the handle to the body, which are also capable of guaranteeing rapid and easy disassembly of the same handle.

A further purpose of the invention is to devise a guitar that comprises new fixing means for rapid and precise fixing of the handle to the body, which are adapted to be additionally used to hook one of the ends of the guitar shoulder-strap in order to conceive their primary function.

A further purpose of the present invention is to devise a guitar that comprises new fixing means for rapid and precise fixing of the handle to the body, which allow for eliminating the unaesthetic metal reinforcement plate from the back side of the body, while guaranteeing reliable and resistant fixing.

Another purpose of the invention is to devise a guitar that comprises new fixing means for rapid and precise fixing of the handle to the body, which can be associated with means used to adjust the inclination of the guitar handle.

All above purposes have been achieved by the present invention, the is essential characteristics of which are illustrated in detail in the first claim.

The guitar of the invention comprises a handle on the end section of which a cylindrical metal stem is fixed centrally and perpendicularly to it, being provided near the lower tip with a through diametral hole, the opposite openings of which are given elliptical flaring, with longitudinal axis parallel to said stem.

The guitar of the invention also comprises a tightening pin that ends with a conical tip and is screwed into a threaded bush previously recessed in the centre of the lateral wall of the guitar body under the point where the handle is attached to the body.

Said bush is also provided with a first threaded hole and a second unthreaded hole orthogonally intersecting the first hole; said second hole has the same diameter as the cylindrical stem, which can therefore be exactly inserted into it.

More precisely, after assembling and tightening the handle, the longitudinal axis of said bush is perpendicular to the longitudinal axis of the cylindrical stem and perfectly centered with said hole with flared openings, where the conical tip of said tightening pin, screwed on the first threaded hole of the bush, is forced with some resistance.

For major clarity, the description of the guitar of the invention continues with reference to the enclosed drawings, which are only for illustrative, not limitative purposes, wherein:

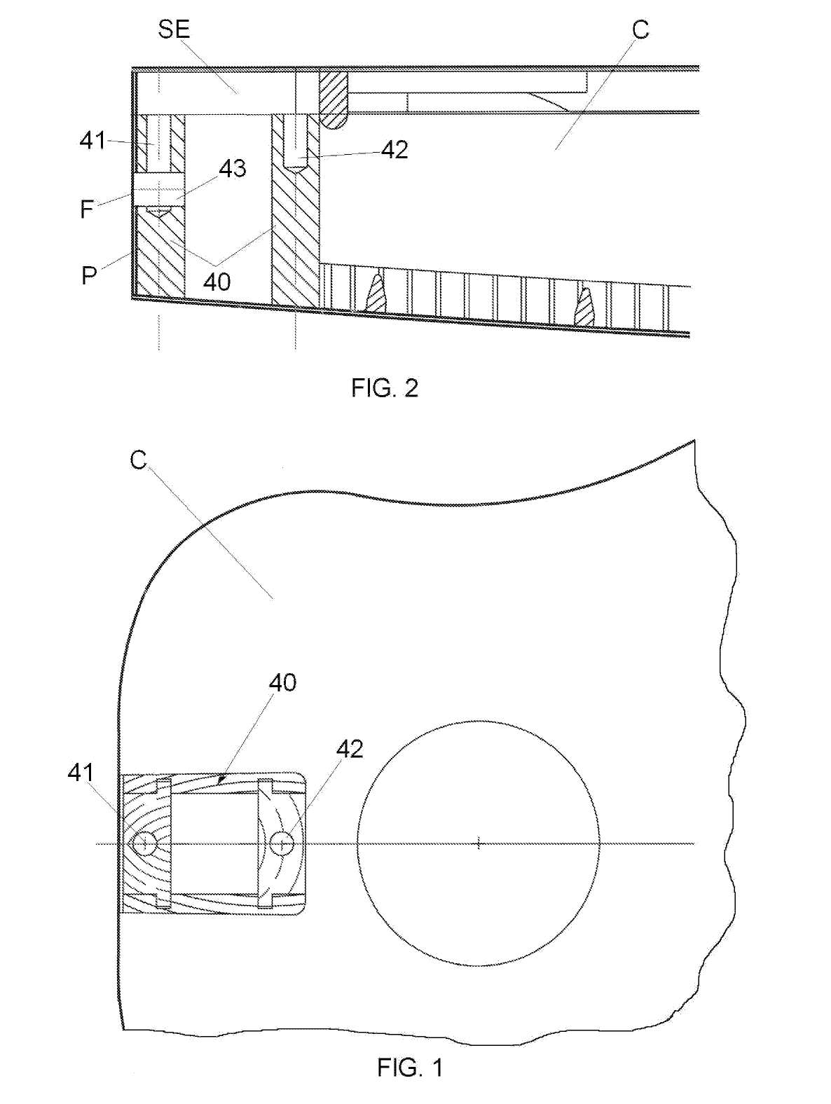

FIG. 1 is a top view of the seat of the handle obtained on the front side of the guitar body;

FIG. 2 is a sectional view of FIG. 1 with plane Il-Il coinciding with the longitudinal axis of the handle, not shown in this figure;

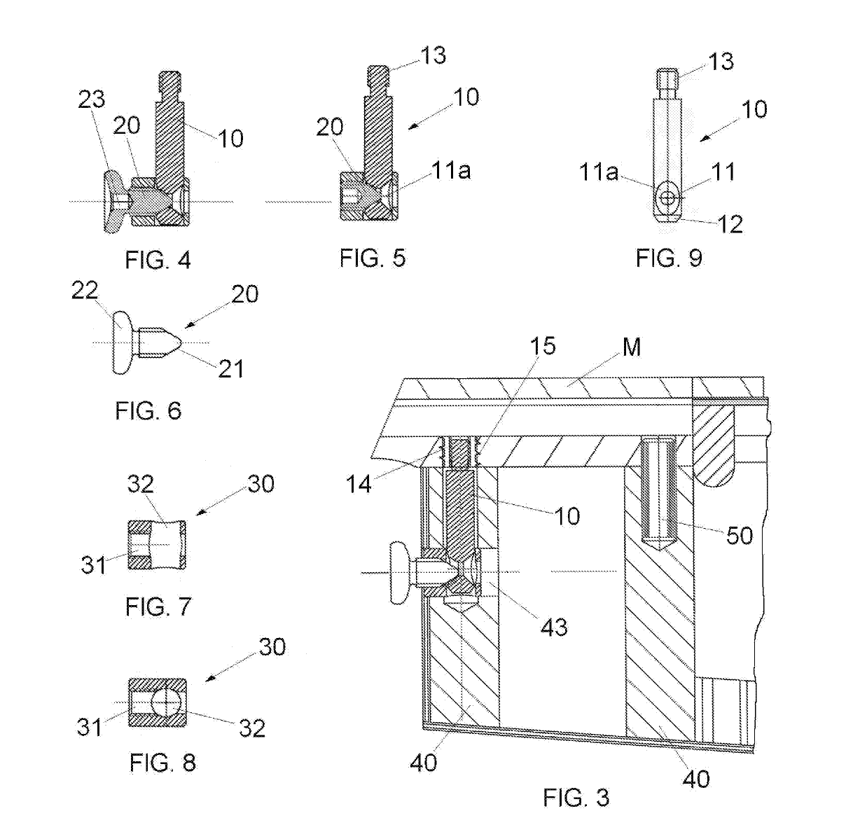

FIG. 3 is basically the same sectional view as FIG. 2 except for it shows the handle (or, more precisely, the end section of the handle) fixed to the body;

FIG. 4 is a view of said cylindrical stem, said threaded bush and said tightening pin in mutual configuration after fixing and tightening the handle;

FIG. 5 is the same as FIG. 4, except for it shows an alternative embodiment of is the tightening pin;

FIG. 6 is a view of said tightening pin in the first embodiment shown in FIG. 4;

FIG. 7 is a sectional view of said threaded bush with a first axial plane;

FIG. 8 is a sectional view of said threaded bush with a second axial plane orthogonal to the first plane;

FIG. 9 is a view of said cylindrical stem.

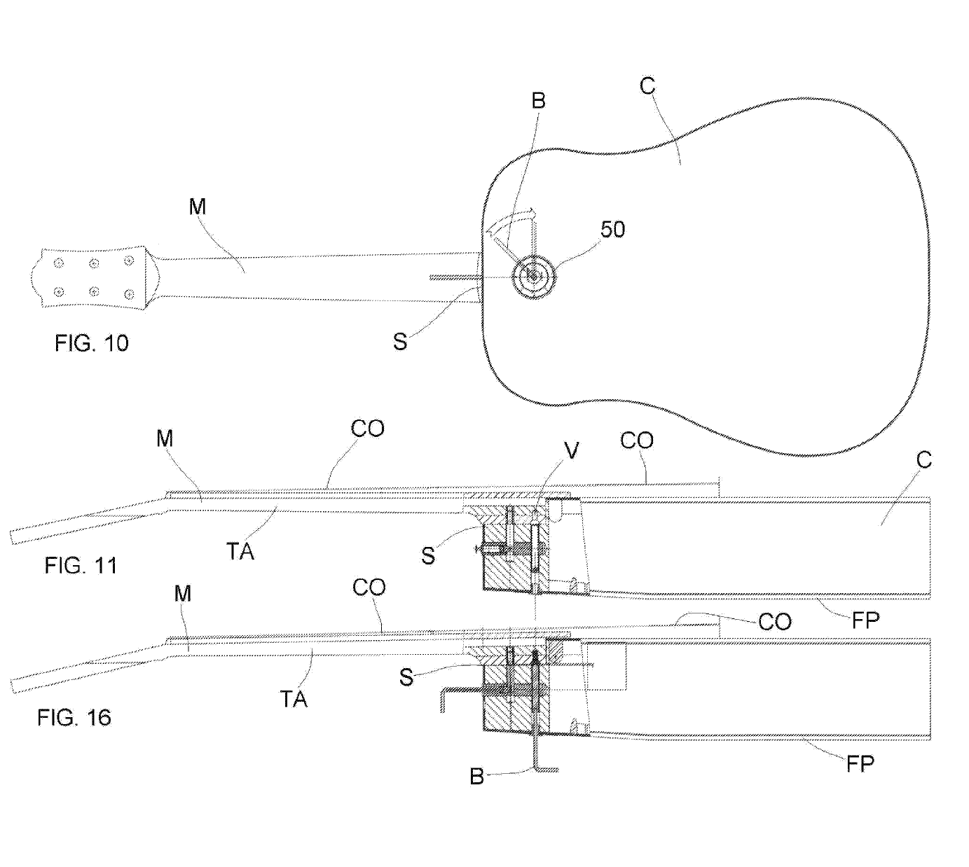

FIGS. 10 to 16 refer to a second embodiment of the invention.

FIG. 10 is a rear view of the guitar;

FIG. 11 is a side view of the guitar with a sectional view of the area where the handle is fixed to the body;

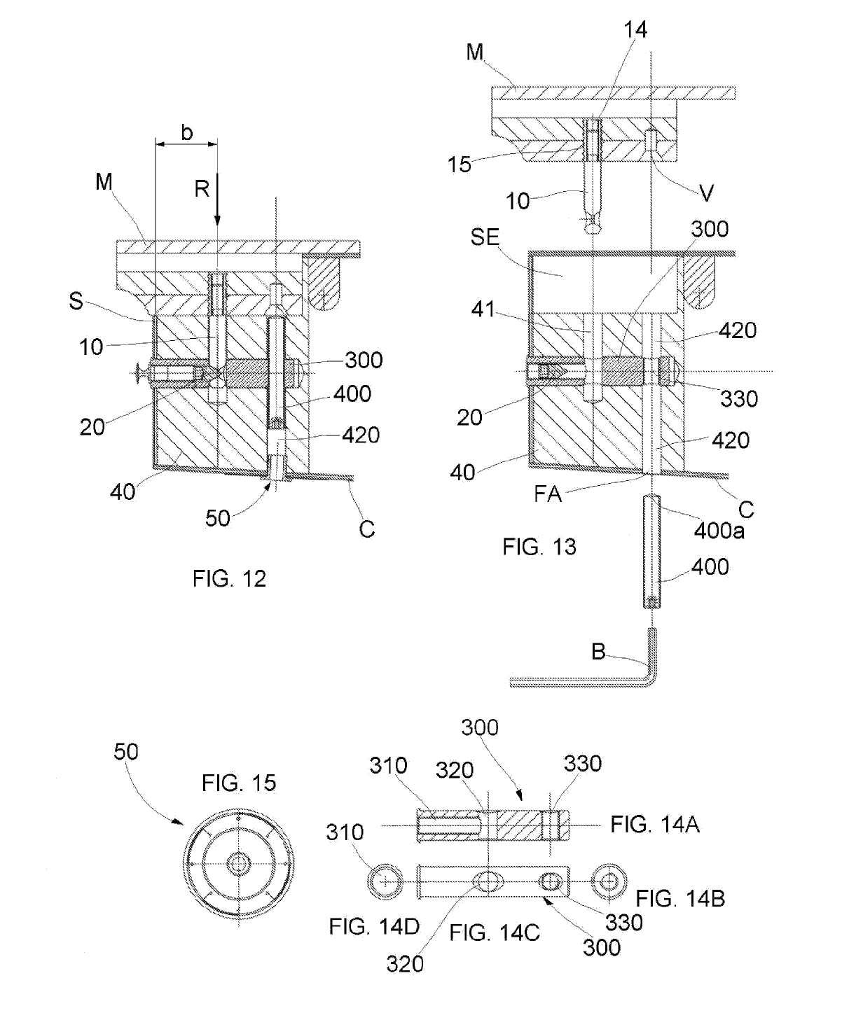

FIG. 12 is an enlarged view of the sectional view of FIG. 11;

FIG. 13 is an exploded view of FIG. 12;

FIGS. 14A, 14B, 14C and 14D are a sectional view and three views of the cylindrical stem, with through hole with elliptically flared openings, used in the embodiment of FIG. 11;

FIG. 15 is a view of a constructive detail of the guitar of the invention;

FIG. 16 is basically the same view as 11, except for the different inclination of the handle.

Referring to FIGS. 3 to 9, the guitar of the invention comprises a handle (M) fixed to the body (C) by means of a cylindrical stem (10) fixed to the handle, and a tightening pin (20) applied on the lateral wall (P) of the body (C) and engaged into a hole (11) obtained near the tip (12) of said cylindrical stem (10).

More precisely, the metal cylindrical stem (10) is provided near the tip (12) with a through diametral hole (11), the opposite openings (11a) of which are given elliptical flaring with truncated-conical profile, with longitudinal axis parallel to the stem.

From the opposite side of the tip (12), said stem (10) ends with a threaded section (13) that is screwed into a metal bush (14), the external surface of which is provided with self-tapping thread for wood (15).

Said tightening pin (20) ends with a conical tip (21) and is screwed into a threaded hole (31) that axially crosses a bush (30), which is provided with a diametral unthreaded through hole (32), orthogonally intersecting the threaded hole (31) and provided with the same diameter as the cylindrical stem (10) that can therefore be exactly inserted into it with possibility of free sliding.

In the embodiment of FIG. 6, the tightening pin (20) has a button-shaped head (22) centrally provided with a polygonal seat (23) for insertion of an Allen screw.

In the embodiment of FIG. 5, the polygonal seat (23) is obtained on the end section of the pin (20) at the conical tip (21).

The guitar of the invention also comprises a wooden frame (40), called “heel”, inside the body (C), provided with at least one, preferably two parallel blind holes (41 and 42), with axis perpendicular to the handle (M), as shown in FIGS. 1 and 2.

Said frame (40) must have a third hole (43) orthogonal to the first two holes and engaged against the lateral wall (P) of the body (C), which is in turn provided with a hole (F) used to access the hole (43).

At least one (41) of said blind holes (41 and 42) has the same diameter as the cylindrical stem (10) and depth higher than the length of the stem (10).

Said bush (30) is recessed into the hole (43) in such a way that the unthreaded hole (32) is perfectly aligned with said hole (41).

Said bush (14) is screwed in lower position to the handle (M), in such a way that the cylindrical stem (10) associated with it becomes perpendicular to the handle (M).

The sequence of operations used to fix and tighten the handle (M) to the body (C) of the guitar is described below.

The end section of the handle (M) is engaged inside the corresponding seat (SE) obtained on the front side of the body (C) thus inserting the stem (10) into the hole (41) until the tip (12) is inserted into the hole (32) of the bush (30).

When the end section of the handle (M) is completely recessed into the seat (SE), the faceted openings (11a) of the hole (11) are interfaced with the threaded hole (31) of the bush (30), but the hole (11) is off-centered with respect to the longitudinal axis of said threaded hole (31).

The misalignment degree can be predetermined as desired by screwing more or less the stem (10) with respect to the bush (14).

Now it is simply necessary to insert and screw into the hole (31) the tightening pin (20), the conical tip (21) of which interferes with the truncated-conical flaring (11a) that surrounds the hole (11) of the cylindrical stem (10).

Because of the interference between conical tip (21) and truncated-conical flaring (11a), during the progressive forward movement of the tip (21), the stem (10) is subject to an increasingly tensile stress that calls it back inside the hole (41), thus tightening the handle (M) inside the seat (SE).

According to the preferred embodiment of the guitar of the invention, a cylindrical wooden peg (50) is recessed into the second blind hole (42), after being fixed under the handle (M).

As mentioned in the premise, the head (22) of the pin (20) can be used as button to hook the guitar shoulder-strap.

Following is a description of the second embodiment of the invention, which is shown in FIG. 10 and following figures. It must be noted that the parts of the invention that do not suffer any modification are indicated with the same numerals used above, omitting their description.

According to this second embodiment, the bush (30) is replaced with a long pin (300) that extends through the entire wooden frame (40), as shown in FIG. 12.

Referring to FIGS. 14A, 14B, 14C and 14D, said pin (300) is provided, for approximately half of its length, with an axial threaded conduit (310) ending in a first diametral unthreaded through hole (320) with same diameter as the cylindrical stem (10), which can therefore be exactly inserted into it with possibility of free sliding.

Along the other half of its length, said pin (300) is provided with a second diametral threaded hole (330) with axis perfectly parallel to the axis of the first unthreaded hole (320).

A register screw (400) is screwed into said second threaded hole (320), being inserted into an unthreaded conduit (420) crossing the entire frame (40), from the back to the front of the body (C), on the back side of which (FP) a hole (FA) used to access the conduit (420) is obtained.

A metal insert (V) is recessed in the back side of the handle (M), which can be for example an ordinary biting screw, in perfectly coaxial position and interfaced to said conduit (420).

By screwing said screw (400) inside the hole (320) it is possible to have the tip (400a) interfere against said metal insert (V), which is exclusively designed to create a rigid support for the tip of the screw (400).

Said interference is converted into a thrust against the back side of the handle (M), the inclination of which with respect to the fingerboard increases as the tip of the screw (400) protrudes outside the conduit (420), as shown in FIG. 16.

Obviously, upon varying the angular position of the handle (M) the distance of the strings (CO) from the fingerboard (TA) will change, decreasing when the inclination of the handle increases.

Referring to FIG. 10, it must be noted that an annular crown-shaped insert (50) is applied on the opening of the conduit (420), on which a graduated angular scale is printed, which is used by the user to read the distance of the strings (CO) from the fingerboard (TA) for each turn angle of the register screw (400); in such a case an Allen register screw (400) must be used in such a way that the transversal arm of the Allen screw (B) acts as reading index of said distance of the strings from the fingerboard with respect to the graduated scale.

The second embodiment of the invention guarantees higher resistance against the bending stress of the handle that tends to detach it from the body. By comparing, in fact, the handle to a first degree lever with fulcrum in the attachment corner (S) to the body (C), it is evident that in such a second embodiment the arm (b) of the resistant force (R) is higher than the first embodiment.

The resistant force (R) is exerted by the cylindrical stem (10) hooked and driven by the tightening pin (20).

The replacement of the bush (30) with the pin (300) has allowed for spacing from said attachment corner (S) the hole (41) in which the cylindrical stem (10) is inserted, which is responsible for resisting possible overturning forces applied on the handle (M).

1. A guitar comprising:
a body having a lateral wall,
an handle fixed to the body by means of a tightening pin, said handle having an attachment corner,
a cylindrical stem perpendicularly fixed to an end section of the handle, said cylindrical stem having a tip with a diametral hole,
wherein said tightening pin is screwed into an element with longitudinal axis orthogonal to the axis of the cylindrical stem,
wherein
said tightening pin has a conical tip,
said diametral hole of the cylindrical stem has opposite openings of which are given elliptical flaring, with truncated-conical profile, adapted to interact with the conical tip of said tightening pin,
wherein said element, in which the tightening pin is screwed, is recessed into the centre of the lateral wall of the body of the guitar, in an area under the attachment corner of the handle to the body.

2. The guitar as claimed in claim 1, wherein the body comprises a wooden frame, provided with at least a first hole with axis perpendicular to the handle and same diameter as the cylindrical stem and a depth higher than the length of the stem; said frame being provided with a second hole, which intersects the first hole perpendicularly and is engaged against the lateral wall of the body that is in turn provided with an access hole to the second hole.

3. The guitar as claimed in claim 2, wherein said element comprises a bush recessed into said second hole of the frame and provided with a first threaded hole, axially oriented, ending in a second unthreaded hole orthogonally intersecting the first hole; said second hole of the bush having the same diameter as the cylindrical stem, so that the cylindrical stem can be inserted into the second hole of the bush with possibility of free sliding.

4. The guitar as claimed in claim 2, wherein said element comprises a pin recessed into said second hole of the frame and said pin being provided, for approximately half of its length, with an axial threaded conduit ending in a first diametral unthreaded through hole with same diameter as the cylindrical stem, so that said cylindrical stem can be exactly inserted and slide freely into said first diametral unthreaded through hole of the pin; whereas along the other half of its length, said pin is provided with a second diametral threaded hole with axis perfectly parallel to the axis of the first unthreaded hole of the pin.

5. The guitar as claimed in claim 4, further comprising a register key screwed into said second threaded hole of the pin and inserted into an unthreaded conduit parallel to said first hole of the frame and entirely crossing the frame from the back to the front of the body, said body having a back side with a hole for accessing the conduit.

6. The guitar as claimed in claim 5, further comprising a metal insert recessed in the back side of the handle in coaxial position and interfaced to said conduit.

7. The guitar as claimed in claim 6, wherein on the opening of the conduit an annular crown-shaped insert is applied, on which a graduated angular scale is printed, which is used by the user to read the distance of the strings from the fingerboard for each turn angle of the register key.

8. The guitar as claimed in claim 1, wherein said stem ends, on the side opposite to the tip, with a threaded section screwed into a metal bush externally provided with a self-tapping thread for wood that allows it to be screwed into the handle.

9. The guitar as claimed in claim 1, wherein said tightening pin is provided with a button-shaped head and centrally provided with a polygonal seat for the insertion of an Allen screw.
